(19) United States
(12) Patent Application Publication
(10) Pub. No.: US 2023/0112471 A1
(43) Pub. Date: Apr. 13, 2023

(54) Shared Ride Hail Service Platform Gaming Experience

(71) Applicant: Ford Global Technologies, LLC, Dearborn, MI (US)

(72) Inventors: Dominique Meroux, San Francisco, CA (US); Sandhya Bhaskar, Sunnyvale, CA (US); Zhilai Shen, Santa Clara, CA (US); Divya Juneja, Dearborn, MI (US); Shubh Gupta, Fremont, CA (US); Feng Jin, Tucson, AZ (US)

(73) Assignee: Ford Global Technologies, LLC, Dearborn, MI (US)

(21) Appl. No.: 17/497,169

(22) Filed: Oct. 8, 2021

(51) Int. Cl. G01C 21/34; B60K 35/00; B60W 40/08; G06Q 30/02

(52) U.S. Cl. CPC G01C 21/3407; B60K 35/00; B60W 40/08; G06Q 30/0209; B60K 2370/16; B60W 2540/221; G06Q 50/30

(57) ABSTRACT

A system for providing a gaming platform for a shared ride hail trip includes a processor programmed to determine a user game objective for a user requesting the shared ride hail trip, determine a ride hail provider objective associated with the shared ride hail trip, generate a ride hail route option based on the user game objective and the ride hail provider objective, and award game points based on user actions such as selecting routes that use transportation modes that mitigate deviation from faster roads or longer routes, or reduce need for operation of a larger vehicle during peak demand times. The system also awards points for user route choices that supports other passengers’ needs and goals such as time constraints, physical limitations, or conservation of time or vehicle emissions. The system may encourage user behaviors that enrich user experience, and achieve user physical fitness and societal goals.

### FIELD

The present disclosure relates to ride hail systems, and more particularly, to a ride hail system having integrated games and user objective options for optimizing ride hail services.

### BACKGROUND

Inefficiencies may arise when a pooled ride hail service picks up multiple passengers each at their own respective pickup location, where many of the riders may have a different drop-off location. The drop off locations may be on respectively slower roads when compared to a direct path along a main thoroughfare. Deviations from major roads onto smaller streets to pick up and drop off riders and /or goods can introduce inefficiencies, reduced profitability for the ride hail provider, and may further introduce diminished customer satisfaction for dynamic ride services. The inefficiencies are often associated with on-board ride hail passengers deviating from a faster direct path to their destination while the ride hail vehicle proceeds from a present location to pickup and drop-off locations of on-board and new passengers. These inefficiencies may also reduce any societal benefits by reducing service accessibility, increasing rider travel time, and increasing environmental impact.

Conventional shared ride hail transportation systems may not offer users ways to share ride hail services with other like-minded riders having similar objectives that may support their consumer interests such as environmental conservation, conservation of ride time, fitness, or entertainment as part of the service. In other aspects, conventional ride hail systems do not include features that reward game points based on route deviation allowance, vehicle selection, and/or vehicle exit points that conserve time and energy for the ride hail group.

A system that provides a more efficient strategy may convince customers to prefer to walk or take micro-mobility (e.g., personal transportation devices or modes such as walking, jogging, using a manual or electric scooter, etc.) for the last segment on these smaller streets, which generates exercise health benefits, may provide a competitive advantage for a ride hail service provider, and increase user satisfaction with shared ride hail services.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 illustrates a functional block diagram of a ride hail game system in accordance with an embodiment.

FIG. 3 illustrates a data flow diagram for the ride hail game system of FIG. 2 in accordance with an embodiment.

FIG. 4 depicts a flow diagram of an example method for providing a gaming platform for a shared ride hail trip in accordance with the present disclosure.

### DETAILED DESCRIPTION

### Overview

The systems and methods disclosed herein are configured and/or programmed to provide a gaming platform for a shared ride hail trip by encouraging user actions and choices that support user-provided objectives, objectives and goals of fellow passengers, and profit and operational objectives of a ride hail service provider. The disclosed system may provide a seamless gaming experience through a shared-ride service platform delivered via vehicle systems and/or user-carried mobile devices, which may influence a consumer to modify existing behaviors that can facilitate routing efficiencies of mobility services while serving customer and societal interests and objectives.

In one embodiment, the system may determine a game objective for a user requesting the shared ride hail trip. The objective can include one or more objectives such as time conservation (e.g., getting to the destination in the shortest possible time), environmental concerns such that vehicle emissions are conserved, or physical constraints such as a large volume of carry-on luggage, physical mobility limitations, user age, among other possible objectives. The user objectives may further include physical fitness such that a portion of the user’s route planning can be designed to include a form of physical activity such as walking, jogging, running, bicycling, or similar activities.

The disclosed system may also determine a ride hail provider objective associated with the shared ride hail trip, and balance the provider objectives with those of the users such that ride hail objectives are maximized while optimizing the user experience. Ride hail provider objectives can include such things as profit maximization, full ride hail vehicle utilization, and route/travel distance minimization, among other possible ride hail provider concerns.

In one embodiment, the system may generate a ride hail route option for the ride hail user based on the user game objective and the ride hail provider objective, and award game points based on user actions such as selecting routes that use alternate modes of transportation that mitigate need for deviation from faster roads or longer routes, or reduces need for operation of a larger vehicle during peak demand times. For example, rewards earned by player selection of a route that includes alternate mode(s) of transport on trip segments may mitigate the need for costly deviation from faster roads with high demand and/or operator use of larger vehicles during peak travel hours. The players may progress during a trip toward personalized goals such as positive sustainability impact or improved physical fitness, with trip options designed to help the player achieve these goals.

According to one example embodiment, the system may also award points for user route choices that can help meet other passengers’ needs and goals such as time constraints (e.g., a fellow ride hail passenger is in a hurry to arrive at their destination), physical mobility of the user and other passengers, and/or conservation of vehicle emissions to mitigate environmental impact of the service.

In one embodiment, the disclosed system may also award points associated with user actions that support advertising partnership goals, such as consuming food and beverages available along the travel route by vendors associated with the ride hail service provider.

Additionally, the system may deduct points for user actions that fail to support ride hail operator and/or user objectives. For example, if a user indicates that physical fitness is an objective, the system may deduct points for drop off selection that provides only a minimal amount of physical activity when more exercise was available based on geographic circumstances.

Game rules may provide behavioral nudges that can encourage system-optimal user actions using award points and point deductions for sub-optimal choices such as opting for drop off at the destination instead of walking a short distance. The disclosed system may encourage ride hail user behaviors that enrich user experience, and achieve user physical fitness and societal goals.

The term ride hail may encompass other similar use cases. For example, ridehail as included herein may refer to traditional ride hail service and/or any similar shared use of a vehicle. For example, ride hail may include Uber® like services or the like. Ride hail may also include a carpool where a carpool rider may arrive at or exit the trip closer to a main road to meet fitness/sustainability goals. In another example, in order to avoid using a larger bus (or deploying a second bus), some bus riders might be rewarded to exit a stop early to add progress toward fitness/sustainability goals, etc. Any vehicle or service directed to providing transportation to multiple passengers may utilize the systems and methods disclosed herein.

### Illustrative Embodiments

The disclosure will be described more fully hereinafter with reference to the accompanying drawings, in which example embodiments of the disclosure are shown, and not intended to be limiting.

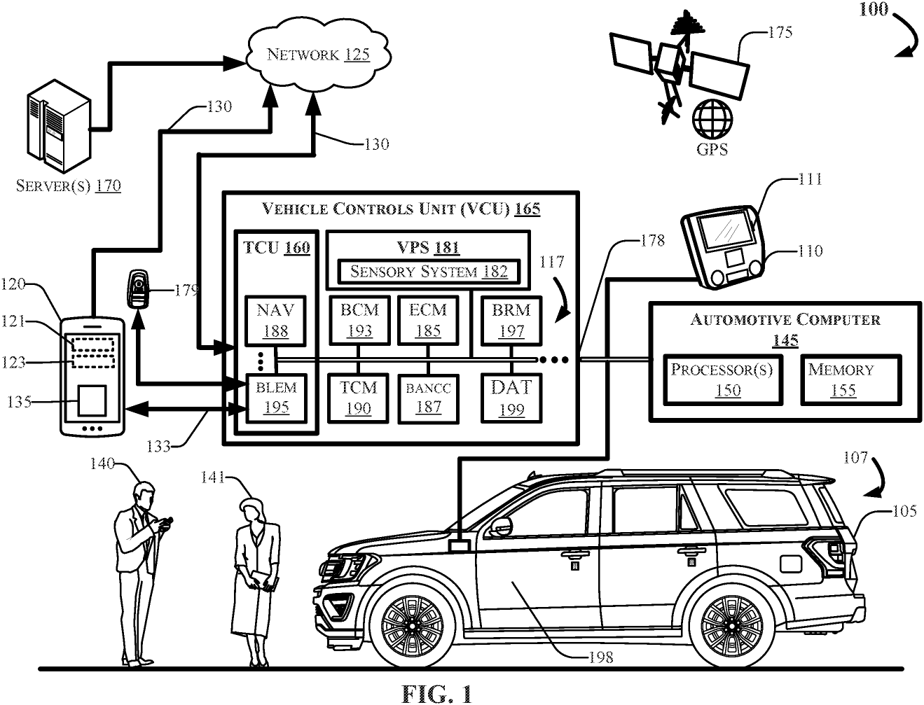

FIG. 1 depicts an example computing environment 100 that can include a vehicle 105. The vehicle 105 may be one vehicle of a vehicle fleet (fleet not shown in FIG. 1) that may be operated by a ride hail service provider (e.g., a mobility services provider). The vehicle 105 may include an automotive computer 145, and a Vehicle Controls Unit (VCU) 165 that can include a plurality of electronic control units (ECUs) 117 disposed in communication with the automotive computer 145. A mobile device 120, which may be associated with one or more ride hail passengers (users), such as a first user 140 and a second user 141. may connect with the automotive computer 145 using wired and/or wireless communication protocols and transceivers. The mobile device 120 may be communicatively coupled with the vehicle 105 via one or more network(s) 125, which may communicate via one or more wireless connection(s) 130, and/or may connect with the vehicle 105 directly using near field communication (NFC) protocols, Bluetooth® protocols, Wi-Fi. Ultra-Wide Band (UWB), and other data connection and sharing techniques.

The vehicle 105 may also receive and/or be in communication with a Global Positioning System (GPS) 175. The GPS 175 may be a satellite system (as depicted in FIG. 1) such as the global navigation satellite system (GLNSS), Galileo, or navigation or other similar system. In other aspects, the GPS 175 may be a terrestrial-based navigation network. In some embodiments, the vehicle 105 may utilize a combination of GPS and Dead Reckoning responsive to determining that a threshold number of satellites are not recognized.

The automotive computer 145 may be or include an electronic vehicle controller, having one or more processor(s) 150 and memory 155. The automotive computer 145 may, in some example embodiments, be disposed in communication with the mobile device 120. and one or more server(s) 170. The server(s) 170 may be part of a cloud-based computing infrastructure, and may be associated with and/or include a Telematics Service Delivery Network (SDN) that provides digital data services to the vehicle 105 and other vehicles (not shown in FIG. 1) that may be part of a vehicle fleet.

Although illustrated as a sport utility, the vehicle 105 may take the form of another passenger or commercial automobile such as, for example, a car, a truck, a crossover vehicle, a van, a minivan, a taxi. a bus, etc., and may be configured and/or programmed to include various types of automotive drive systems. Example drive systems can include various types of internal combustion engines (ICEs) powertrains having a gasoline, diesel, or natural gas-powered combustion engine with conventional drive components such as, a transmission, a drive shaft, a differential, etc. In another configuration, the vehicle 105 may be configured as an electric vehicle (EV). More particularly, the vehicle 105 may include a battery EV (BEV) drive system, or be configured as a hybrid EV (HEV) having an independent onboard powerplant, a plug-in HEV (PHEV) that includes a HEV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a fuel cell vehicle (FCV) that converts liquid or solid fuel to usable power using a fuel cell, (e.g., a hydrogen fuel cell vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4.

A vehicle having a Level-0 autonomous automation may not include autonomous driving features.

A vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system failure.

Level-5 AVs may include fully autonomous vehicle systems that require no human input for operation, and may not include human operational driving controls.

According to embodiments of the present disclosure, the ride hail game system 107 may be configured and/or programmed to operate with a vehicle having a Level-0 (no AV capabilities) to a Level-5 (fully self-driving) controller. Accordingly, the ride hail game system 107 may provide some aspects of human control to the vehicle 105, when the vehicle is configured as an AV.

The mobile device 120 can include a memory 123 for storing program instructions associated with an application 135 that, when executed by a mobile device processor 121, performs aspects of the disclosed embodiments. The application (or “app”) 135 may be part of the ride hail game system 107, or may provide information to the ride hail game system 107 and/or receive information from the ride hail game system 107. For example, the app 135 may cause the mobile device processor 121 to communicate game information associated with the users 140, 141, etc. that may be associated with a ride hail trip. For example, the mobile device processor 121 may receive information from and/or transmit information to the server(s) 170 that may operate the ride hail provider platform. The server(s) 170 may store user profile information (described in greater detail with respect to FIG. x), where information associated with user 140/141 preferences and objectives may be stored. For example, the server(s) 170 may include user profile information having previous user trip data, game information, aggregated points information, awards and monetary rebates associated with achieving user and/or provider objectives, etc.

In some aspects, the mobile device 120 may communicate with the vehicle 105 through the one or more wireless connection(s) 130, which may be encrypted and established between the mobile device 120 and a Telematics Control Unit (TCU) 160. For example, the 121 may cause the vehicle 105 to plan a particular route and/or alter the route based on user interaction with the 111. In cases where the vehicle 105 is semi-autonomous or manually driven vehicle, the 170 may transmit route instructions to the mobile device 120 and/or the infotainment system 110 associated with the vehicle 105, such that the vehicle operator (not shown in FIG. 1) may alter the route based on user interactive selections and/or system-driven or user-driven route choices.

The mobile device 120 may communicate with the TCU 160 using a wireless transmitter (not shown in FIG. 1) associated with the TCU 160 on the vehicle 105. The transmitter may communicate with the mobile device 120 using a wireless communication network such as, for example, the one or more network(s) 125. The wireless connection(s) 130 are depicted in FIG. 1 as communicating via the one or more network(s) 125. and via one or more wireless connection(s) 133 that can be direct connection(s) between the vehicle 105 and the mobile device 120. The wireless connection(s) 133 may include various low-energy protocols including, for example, Bluetooth®, Bluetooth® Low-Energy (BLE®). UWB, Near Field Communication (NFC), or other protocols.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication protocols such as, for example, transmission control protocol/Internet protocol (TCP/IP), Bluetooth®. BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the ride hail game system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g.. the memory 155 and/or one or more external databases not shown in FIG. 1). The processor(s) 150 may utilize the memory 155 to store programs in code and/or to store data for performing aspects in accordance with the disclosure. The memory 155 may be a non-transitory computer-readable memory storing a ride hail game program code. The memory 155 can include any one or a combination of volatile memory elements (e.g., Dynamic Random Access Memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

The VCU 165 may share a power bus 178 with the automotive computer 145. and may be configured and/or programmed to coordinate the data between vehicle 105 systems, connected servers (e.g., the server(s) 170), and other vehicles (not shown in FIG. 1) operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, the TCU 160, a Body and Network Communication Controller (BANCC) 187. a Driver Assistances Technologies (DAT) controller 199, etc. The VCU 165 may further include and/or communicate with a Vehicle Perception System (VPS) 181, having connectivity with and/or control of one or more vehicle sensory system(s) 182. In some aspects, the VCU 165 may control operational aspects of the vehicle 105, and implement one or more instruction sets received from the application 135 operating on the mobile device 120, from one or more instruction sets stored in computer memory 155 of the automotive computer 145, including instructions operational as part of the ride hail game system 107.

The TCU 160 can be configured and/or programmed to provide vehicle connectivity to wireless computing systems onboard and offboard the vehicle 105. and may include a Navigation (NAV) receiver 188 for receiving and processing a GPS signal from the GPS 175, a BLE® Module (BLEM) 195, a Wi-Fi transceiver, a UWB transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and BLE® communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests, and connect directly with the mobile device 120, and/or one or more keys (which may include, for example, the fob 179).

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high-speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, the ride hail game system 107. and/or the server(s) 170. etc.), and may also communicate with one another without the necessity of a host computer. The bus 180 may connect the ECUs 117 with the automotive computer 145 such that the automotive computer 145 may retrieve information from, send information to, and otherwise interact with the ECUs 117 to perform steps described according to embodiments of the present disclosure. The bus 180 may connect CAN bus nodes (e.g., the ECUs 117) to each other through a two-wire bus, which may be a twisted pair having a nominal characteristic impedance. The bus 180 may also be accomplished using other communication protocol solutions, such as Media Oriented Systems Transport (MOST) or Ethernet. In other aspects, the bus 180 may be a wireless intra-vehicle bus.

The VCU 165 may control various loads directly via the bus 180 communication or implement such control in conjunction with the BCM 193. The ECUs 117 described with respect to the VCU 165 are provided for example purposes only, and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human drivers, inputs from an autonomous vehicle controller (not shown in FIG. 1), the ride hail game system 107. and/or via wireless signal inputs received via the wireless connection(s) 133 from other connected devices such as the mobile device 120, among others. The ECUs 117, when configured as nodes in the bus 180. may each include a central processing unit (CPU), a CAN controller, and/or a transceiver (not shown in FIG. 1). For example, although the mobile device 120 is depicted in FIG. 1 as connecting to the vehicle 105 via the BLEM 195, it is possible and contemplated that the wireless connection(s) 133 may also or alternatively be established between the mobile device 120 and one or more of the ECUs 117 via the respective transceiver(s) associated with the module(s).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems. AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

The BANCC 187 may connect with the DAT controller 199 configured and/or programmed to provide biometric authentication controls, including, for example, facial recognition, fingerprint recognition, voice recognition, and/or other information associated with characterization, identification, and/or verification for other human factors such as gait recognition, body heat signatures, eye tracking, etc. In some aspects, ride hail game system 107 may recognize and/or authenticate the user(s) 140 and 141 using biometric authentication, via a user-entered pass code and/or user name, or via check-in authentication using the mobile device 120 and/or other devices such as a laptop (not shown in FIG. 1), wearable device (not shown in FIG. 1), etc. Accordingly, the authenticated user 140/141 may cause ride hail game system 107 to obtain a user profile (not shown in FIG. 1) that can include user preference information, user objectives, user game points, aggregated game points, and/or other information.

The DAT controller 199 may provide automated driving and driver assistance functionality that can include, for example, active parking assistance, trailer backup assistance, adaptive cruise control, lane keeping, and/or driver status monitoring, among other features. The DAT controller 199 may also provide aspects of user and environmental inputs usable for user authentication. Authentication features may include, for example, biometric authentication and recognition. The DAT controller 199 may connect with and/or include a Vehicle Perception System (VPS) 181, which may include internal and external sensory systems (collectively referred to as sensory system(s) 182). The sensory systems 182 may be configured and/or programmed to obtain sensor data usable for biometric authentication, and for performing driver assistances operations such as, for example, active parking, trailer backup assistances, adaptive cruise control and lane keeping, driver status monitoring, and/or other features. In some aspects, the DAT controller 199 may further include program code that provides aspects of the ride hail game system 107.

The computing system architecture of the automotive computer 145, VCU 165, and/or the ride hail game system 107 may omit certain computing modules. It should be readily understood that the computing environment depicted in FIG. 1 is an example of a possible implementation according to the present disclosure, and thus, it should not be considered limiting or exclusive.

The automotive computer 145 may connect with the infotainment system 110 that may provide an interface for the navigation and GPS receiver (e.g., the NAV receiver) 188, and the ride hail game system 107. The infotainment system 110 may include a touchscreen interface portion 111, and may include voice recognition features, biometric identification capabilities that can identify users based on facial recognition, voice recognition, fingerprint identification, or other biological identification means. In other aspects, the infotainment system 110 may provide user identification using mobile device pairing techniques (e.g., connecting with the mobile device 120, a Personal Identification Number (PIN)) code, a password, passphrase, or other identifying means. In some aspects, the infotainment system 110 may further include multiple interfaces provided throughout the interior of the vehicle 105 such that the first and second user(s) 140, 141, etc., may interact with the ride hail game system 107 by receiving game messages en route, by receiving user feedback and inputs during the trip, and by providing other infotainment services.

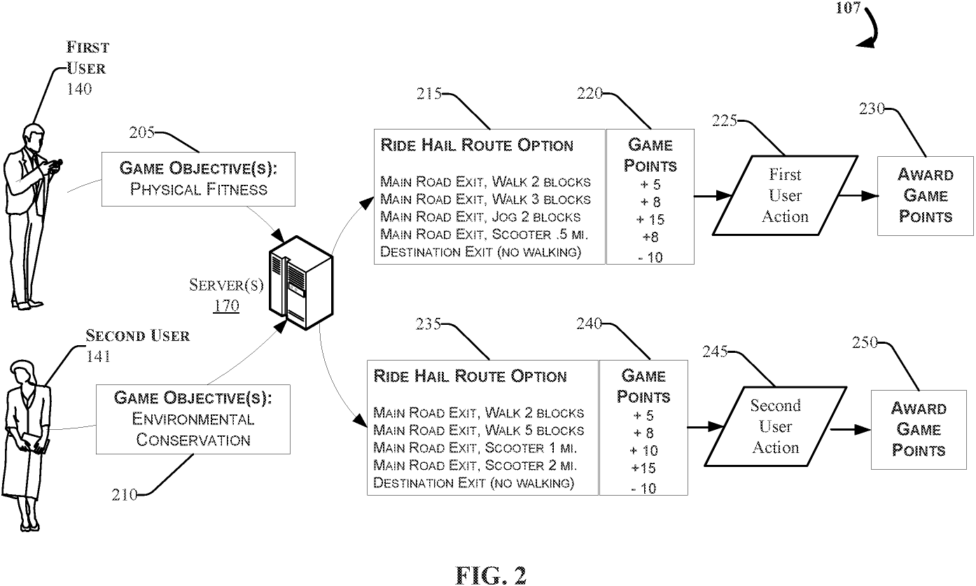

As explained above, inefficiencies may arise when a pooled ride hail service picks up multiple passengers each at their own respective pickup location. For example, as shown in FIG. 2, the first user 140 and the second user 141 may be picked up at two different locations, where the first user 140 is picked up first, then travels with the vehicle 105 (as shown in FIG. 1) to pick up the second user 141, which may be ideally along the route to a destination (not shown in FIG. 2) for the first user 140. In many circumstances, both the first user 140 and the second user 141 may have, respectively, a different drop-off location. In one example, either of the users 140 and/or 141 may schedule a destination (e.g., a drop off location) that may be on respectively slower roads when compared to a direct path along a main thoroughfare. Deviations from major roads onto smaller streets to pick up and drop off riders and /or goods generates inefficiency for dynamic ride services, reducing profitability, customer satisfaction, and societal benefit (accessibility, travel time, environmental sustainability impact). The on-board ride hail passengers (e.g., the user(s) 140 and/or 141) must all deviate from a faster direct path to their respective destination while the ride hail vehicle 105 proceeds from pickup and drop-off locations between a present location and a passenger’s drop-off location.

Additionally, in shared ride hail transportation systems, users (e.g., 140, 141) do not currently have ways to share ride hail services with other like-minded riders that have similar objectives that may support their consumer interests such as environmental conservation, conservation of ride time, fitness, or entertainment during the ride hail ride. In other aspects, conventional ride hail systems do not include features that reward game points based on route deviation allowance, vehicle selection, and/or vehicle exit points that conserve time and energy for the ride hail group.

FIG. 2 illustrates a functional block diagram of the ride hail game system 107. in accordance with an embodiment. The ride hail game system 107 may provide an efficient strategy that may convince customers (e.g., the users 140 and 141) to prefer to walk or take micro-mobility such as a scooter or other personal transportation device for the last segment on these smaller streets. When such options are adopted by users and followed, the ride hail game system 107 may generate exercise health benefits, societal benefits such as energy conservation, carbon emissions reduction, and/or time conservation for other passengers. Moreover, the ride hail game system 107 may provide a competitive advantage for ride hail service providers (not shown in FIG. 2), which may operate the vehicle 105 as part of a shared ride hail service by balancing profit and service motivations.

FIG. 2 illustrates the first user 140 using the first user’s mobile device 120 to enter one or more game objective(s) 205 using the app 135 (shown on FIG. 1) instantiated on the mobile device 120. The app 135 may be disposed in communication with the server(s) 170 via a wireless connection(s) 130 (as shown in FIG. 1), and may transmit user inputs indicative of the game objective(s) 205 to the server(s) 170. Similarly, the second user 141 may select one or more game objective(s) 210. The app 135 may determine the game objective(s) 205 and 210 based on a question-and-answer game profile associated with the ride hail game system 107 such that motivating factors are determined respective to each of the users 140 and/or 141.

The ride hail game system 107 may determine, based on the game objective(s) 205 and 210. ride hail route options that can forward each respective user’s personal, societal, or other values as reflected in the game objective(s). For example, the first user 140 is illustrated as having selected the game objective physical fitness. The user 140 may desire to maintain a healthy body weight, or incorporate moderate or vigorous exercise into their daily commute to and from work. Accordingly, the ride hail game system 107 determines one or more ride hail route options 215 that can help to meet the first user 140 personal objectives. For example, the ride hail game system 107 may generate options that can include exiting the vehicle 105 along the main road, where the destination that the user 140 has indicated may be an additional two blocks away from the main road, which would require navigation and travel along one or more side roads to reach the destination. If the user 140 selects the main road exit option and walks a predetermined distance that may be reasonable for time and physical abilities associated with the first user 140, the ride hail game system 107 may award game points 220 commensurate with the respective ride hail rout option. In the example shown, if the user elects to exit the main road, then walk two blocks to his destination, the system may award 5 game points. If three blocks are walked (a second option that may be selected by the user 140), then 8 points may be awarded when the ride hail game system 107 determines that the destination is reached and the user 140 walks the distance. Similarly, if the user game objective(s) 205 indicates that physical fitness is his objective, then extra points may be awarded for a two-block jog (15 game points), and relatively fewer may be awarded for a traveling the last half mile by scooter (+8 game points). Accordingly, the awarded game points may be commensurate with the relative effort needed by a respective user to execute the selected route option.

Similarly, points may be deducted for options that do not meet the game objective(s) 205, or are less favorable to the user’s objectives, the ride hail service provider’s objectives, or society on the whole. For example, of the user 140 indicates that his game objective is physical fitness, then selects the ride hail route options 215 “destination exit (no walking)”, then the user’s 140 physical fitness level may not be dramatically improved by that option. Accordingly, the ride hail game system 107 may detract 10 points (or some other number commensurate with the relative negative affect on balanced interests of the ride hail service provider, the user 140, and/or other passengers such as the second user 141).

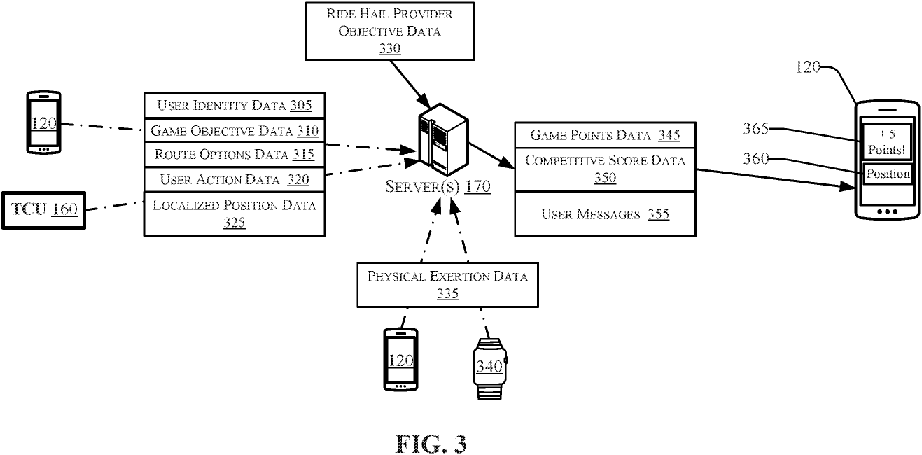

The ride hail game system 107 may determine a first user action 225 using various sensory devices associated with the ride hail game system 107 as a whole (e.g., vehicle sensory devices), and/or via the user mobile device 120. which may report the user activities to the server(s) 170. The interplay of data sharing and flow is explained in greater detail with respect to FIG. 3. The awarded game points 230 may be displayed on the user mobile device 120, and/or shared with other competing ride hail users such as the second user 141.

The second user 141 is illustrated as having selected a game objective “environmental conservation.” Perhaps the second user 141 is concerned with overall vehicle emissions and their impact on environmental health, and wishes to commute to their destination while minimizing the overall impact. Accordingly, the ride hail game system 107 may provide similar ride hail route options that include various modes of secondary transport such as walking or scooter travel for part of the overall ride hail trip. Game points 240 are awarded commensurate with each option’s propensity to satisfy the game objective(s) 210.

It should be appreciated that, although a single game objective is shown for each of the example user’s 140 and 141, it is contemplated that multiple game objectives may be selectable by each user. For example, the first user 140 may select physical fitness as his primary objective, by may also be inclined to support environmental concerns as the second user 141 is, or other objectives such as time conservation. Like the first user 140, the second user 141 may select her game objective(s) 210, the ride hail game system 107 may present various ride hail route options 235 and respective game points 240 associated with each respective option, and the ride hail game system 107 may receive data associated with the second user action 245. Game points may be awarded (or detracted) at step 250 based on the second user action 245.

FIG. 3 illustrates an example data flow diagram for the ride hail game system 107. in accordance with an embodiment. The server(s) 170 may receive inputs from various sources that can include the vehicle 105 systems (e.g., via the TCU 160), from the user’s mobile device(s) (e.g., the mobile device 120 and/or a smart wearable device 340), as well as inputs from the ride hail provider (shown in FIG. 3 as ride hail provider objective data 330). In some aspects, the data 330 may be part of the server(s) 170 functional operation (e.g., the server(s) 170 are operated by the ride hail provider (not shown in FIG. 3). In other aspects, the data 330 may be received by the server(s) 170 from an external computing system.

As illustrated in FIG. 3,the server(s) 170 may receive user identity data 305. game objective data 310. route options data 315, user action data 320, and/or localized position data 325 from the vehicle 105 system(s) such as the TCU 160. and/or from the mobile device(s) 120. The ride hail game system 107 may further receive physiological information (e.g., biometric data) associated with a user (illustrated as physical exertion data 335). The ride hail game system 107 may evaluate a relative physical effort exerted by a user based on the physical exertion data 335, which may indicate whether a respective user has met or exceeded exercise goals, which may be useful in the case of a game objective such as physical fitness.

The ride hail game system 107 may take inputs 305-335 and generate game points data 345 and competitive score data 350. which may be received by mobile devices associated with shared ride hail users (e.g., via the mobile device 120 for example). The mobile device 120 may output generated user messages 365 indicative of game points, game information, selectable options for route options, and other outputs such as aggregate score information or competitive position information 360.

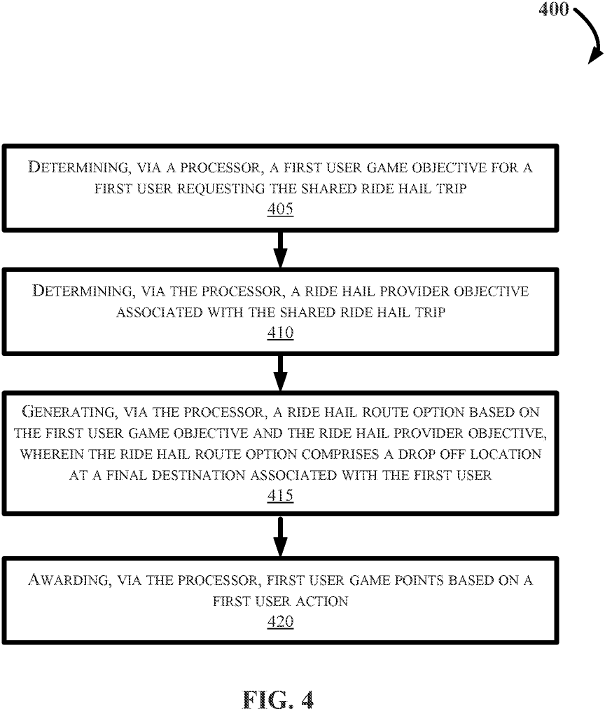

FIG. 4 is a flow diagram of an example method 400 for providing a gaming platform for a shared ride hail trip, according to the present disclosure. FIG. 4 may be described with continued reference to prior figures, including FIGS. 1-3. The following process is exemplary and not confined to the steps described hereafter. Moreover, alternative embodiments may include more or less steps that are shown or described herein, and may include these steps in a different order than the order described in the following example embodiments.

Referring first to FIG. 4, at step 405, the method 400 may commence with determining, via a processor, a first user game objective for a first user requesting the shared ride hail trip. The first user game objective can include one or more game objectives that may include, for example, a physical fitness objective where the first user exerts physical effort that increases their activity level during the shared ride hail trip. Modes of transportation may be included that can include physical activities such as walking, riding a bicycle, jogging, using a scooter, and/or other activities. In another example, determining the first user game objective may include determining a particular fitness goal of the first user. Various fitness goals are contemplated, such as an average heart rate given a predetermined period of time, a maximum hear rate, calories spent during the trip, cumulative weight loss, and/or other possible fitness goals.

In other aspects, the first user game objective can include an environmental conservation objective with the goal of reducing overall energy consumption used on the shared ridehail trip, and therefore reducing vehicle emissions associated with the trip. For example, the environmental conservation objective may include the goal of reducing vehicle travel by user selection of drop-off locations that are along the main thoroughfare and thus avoid the need to deviate from a direct course to navigate to a side street drop off point. Such a choice may reduce vehicle travel in comparison with the ride hail route option that deviates from the main road for travel to the destination point. In another example, reduction in total vehicle emissions can include a comparison with an estimate of vehicle emissions associated with the ride hail route option (e.g., the unaltered trip that delivers the ride hail user all the way to their scheduled location). The vehicle emissions reduction can include a maximum volume of carbon emissions associated with the present trip, a cumulative volume of carbon emissions given a span of time (minutes, days, weeks, months, etc.). In another example embodiment, the environmental conservation game objective may include minimizing cargo weight to reduce vehicle fuel energy usage, minimizing cargo volume to allow for passenger room instead of using the vehicle space for cargo, and/or minimizing travel distance.

In another example embodiment, the first user game objective may include time conservation, where the first user endeavors to minimize trip time as an objective of the shared ride hail game. For example, conservation of time game objectives can include minimizing time for the first user, minimizing time spent for one or more second users, minimizing cumulative time for all shared ride hail users, and/or balancing time minimization with one or other possible first user game objectives.

This step may further include determining the first user game objective for the first user by determining shared ride hail preferences associated with one or more second users. For example, in a prior shared ride hail trip, the first user may have enjoyed the company of a particular second user, and may list the second user as a preferred ride hail companion. Accordingly, this step may further include obtaining, via the processor, a first user group ride hail preference associated with the particular second user, and selecting, via the processor, the second user to pick up along the shared ride hail trip, where the second user is selected based on the first user group ride hail preference.

Another game objective can include a community contribution objective, where the user endeavors to be a good citizen by assisting fellow passengers in achieving their respective game objectives. For example, the determining the community contribution objective may include determining goals that meet societal aims such as improving the mood of one or more second shared ride hail users, saving time for one or more second shared ride hail users, and/or selecting a drop off location that benefits the ride hail service provider such that a fuller utilization of the ride hail vehicle becomes possible based on a first user action. In other aspects, determining the community contribution objective can include determining a potential list of user actions that maximize a count of preferred second users listed as preferred ride hail companions. Accordingly, the shared ride hail service provider may have greater numbers of potential shared ride hail passengers that may be picked up while satisfying user preferences and maximizing user satisfaction.

In another aspect, the community contribution objective may include accommodating a physicality constraint associated with one or more second users. For example, the first user may satisfy the community contribution objective by selecting route options that make pickup and/or drop off easier for one or more second users. This step may include determining one or more objectives that can include acts that assist one or more second users with mobility constraints, such as assisting them to load and/or unload cargo, a personal mobility device such as a wheelchair or walker, and/or assisting other passengers in some way that makes their shared ride hail trip more pleasant, productive, or healthy.

At step 410, the method 400 may further include determining, via the processor, a ride hail provider objective associated with the shared ride hail trip. This step may include determining that ride hail profit is a main objective. This step may further include determining a weighted value associated with one or more ride hail route options, where route options presented to the first user that result in higher profit margin are weighted higher respectively than options that result in a lesser profit margin. This step may further include balancing profit objectives with user satisfaction objectives, such that the system maximizes a predicted user satisfaction metric (e.g., a quantitative value) based on prior data associated with user satisfaction. For example, questionnaire data may be correlated with route options presented having varying degrees of weights with respect to profit margin objectives. The tabulated results may be evaluated as a maximization problem such that a balance is quantifiable between route options associated with profit objectives and route options associated with user satisfaction/goals. Accordingly, the ride hail provider objective may be balanced with user game objectives such that both interests may be maximized and/or optimized with available route options generated by the system and offered for user selection in game play.

At step 415, the method 400 may further include generating, via the processor, a ride hail route option based on the first user game objective and the ride hail provider objective, wherein the ride hail route option comprises a drop off location at a final destination associated with the first user. This step may include, for example, generating a ride hail route option comprising, when the first user game objective is physical fitness, a proposed first user drop off location that allows for a second modality of transportation such that the vehicle minimizes any deviation from a main thoroughfare that may have higher velocity traffic, fewer turns, fewer stops and starts, etc. The second modality of transportation suggested may include walking, running, jogging, travel by manual scooter, or another active mode of personal transport.

In another aspect, generating the ride hail route option can further include generating a drop off location for the first user that includes these same or similar route options when the first user game objective is environmental conservation. Further, this stem may include walking these same distances without offering active physical modalities such as jogging or running, since physical fitness may not be the first user’s objective.

According to another embodiment, responsive to the ride hail provider objective, this step may further include determining, via the processor, a localized position of a vehicle providing the shared ride hail trip, determining, based on the localized position and the first user game objective, that the first user is proximate to a bonus point award location, and generating, via the processor, a user message displayable on a mobile device associated with the first user. The user message may be indicative that the first user is near the bonus point award location. Offering this route option may result in the first user becoming aware of the bonus point award location offering (e.g., food, a beverage, a service, etc.), and taking advantage of that offering such that a paying advertising partner of the ride hail provider experiences an increase in business as a result of the route option presented to the first user.

At step 420. the method 400 may further include awarding, via the processor, first user game points based on a first user action. This step may include determining a user action responsive to the ride hail route option by receiving, via the processor, a user-selectable route option of one or more of a plurality of generated route options, receiving, via the processor,data associated with the user action, and awarding the game points based on the first user action.

For example, the first user action may be associated with a selection of a generated ride hail route option that includes a drop off location three blocks from the first user final destination, where the vehicle avoids several turns and navigation through side roads proximate to the first user’s final destination. This step may include receiving, via a mobile device associated with the first user, an indication of the first user’s adoption of the presented route option, and receiving, via the processor, data associated with the first user’s performance of the selected option. In one example, the first user performance may be a brisk walk for three blocks responsive to a first user game objective that includes physical fitness or environmental conservation.

In another example embodiment, this step may include determining, via the processor, a localized position of a vehicle providing the shared ride hail trip, determining, based on the localized position and the first user game objective, that the first user may receive a point penalty based on an impending user action, and generating, via the processor, a user message displayable on a mobile device associated with the first user. The user message is indicative that the first user may receive a point penalty based on an impending user action. For example, if the first user has indicated that the game objective is physical fitness, this step may further include receiving, via the processor, from a sensory device associated with the first user, one or more of a biometric indicator, a distance indicator, and a travel velocity indicator associated with the physical activity, and awarding the first user game points based on an indication of physical exertion associated with the physical activity. The message displayable on the mobile device may indicate that the user may avoid losing points if he increases his pace such that the heart rate reaches a predetermined threshold associated with the first user’s profile information. Such information may consider age, fitness level, fitness goals, safety measures, etc.

In another example, the first user game objective is an environmental conservation objective such as reducing vehicle emissions, this step may further include awarding the first user game points based on one or more of a reduction in vehicle travel in comparison with the ride hail route option, and a reduction in total vehicle emissions in comparison with an estimate of vehicle emissions associated with the ride hail route option. Accordingly, this step may include estimating total vehicle emissions of the initial planned route (without any early drop offs), estimating a total vehicle emissions of a route option that conserves vehicle travel distance and/or operation time, determining, via the processor, that the first user action satisfies the environmental conservation objective, and awarding the first user game points based on the first user action.

According to another example embodiment, this step may include, when the first user game objective is a time conservation objective, determining, via the processor, that the first user action satisfies the time conservation objective by reducing travel time for one or more second users, and awarding the first user game points based on the first user action. This may, in some aspects, include receiving data, via the processor, associated with the one or more second users, where the data is generated and transmitted by one or more second user devices such as a connected mobile device, a wearable smart device, or the like, and the second user device(s) and sent the data to the server(s) administrating the game platform. The data may include total trip time (e.g., the mobile device GPS may determine that the second user has arrived at the destination and may log a time associated with the second user’s arrival). This step may further include determining, via the processor, that time is conserved for one or more of the second users, and awarding the game points to the first user based on the benefit to the one or more second users. For example, if the one or more second users saved 4 minutes, 10 \. minutes, etc., based on the first user action, then the system may award game points to the first user commensurate with the one or more second user’s time savings. Accordingly, these same steps may apply also to a game objective such as a community objective having the aim that benefits other rider’s health, user contentment, or other societal values.

According to another example embodiment, the first user game objective may be a societal improvement goal that increases health or happiness of others such that the user action aids a physicality constraint associated with another user. This step may include determining, via the processor, that the first user action satisfies a physicality constraint associated with one or more second users, and awarding the first user game points based on the first user action. For example, the first user may assist a second user by loading or unloading their wheelchair in the ride hail vehicle. The assisting user may receive game points for this user action.

In another example embodiment, the physicality constraint may be associated with the first user him/herself. Accordingly, the system may have generated the ride hail route option (at step 415) based on the first user game objective and one or more of the ride hail provider objective and a physicality constraint associated with the first user. In this example, step 420 may include determining, via the processor, that the first user action satisfies a physicality constraint associated with the first user, where the first user action indicates that the first user applied extra effort to overcome their constraint. For example, the system may determine that the first user is carrying three pieces of luggage, but the first user selected at step 415, a ride hail route option where they chose to walk three blocks with their luggage. Such a step may require extra user physical effort and commitment to the first user’s game objective (which may be environmental conservation, time conservation (for other users), physical fitness, or some other objective).

This step may further include awarding the first user game points based on the first user action that reflects a relative amount of extra effort. For example, walking three blocks with one bag may merit an extra 10 bonus game points, where walking three blocks with 3 bags may merit 30 bonus game points. Other scenarios are possible, and thus, these example options are not meant to be exclusionary or a complete list.

As may be the case with any game, it may be advantageous to include options not only for personal competition, but competition with other passengers. Accordingly.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment.” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

Regarding the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others. “can,” “could,” “might.” or “may,” unless specifically stated otherwise, or otherwise understood within the context as used, is intended to convey that certain embodiments could include, while other embodiments may not include, certain features, elements, and/or steps. Thus, such conditional language is not intended to imply that features, elements, and/or steps are in any way required for one or more embodiments.

That which is claimed is:

1. A computer-implemented method for providing a gaming platform for a shared ride hail trip, comprising:
determining, via a processor, a first user game objective for a first user requesting the shared ride hail trip;
determining, via the processor, a ride hail provider objective associated with the shared ride hail trip;
generating, via the processor, a ride hail route option based on the first user game objective and the ride hail provider objective, wherein the ride hail route option comprises a drop off location at a final destination associated with the first user; and
awarding, via the processor, first user game points based on a first user action.

2. The method according to claim 1, further comprising.
obtaining, via the processor, a first user group ride hail preference; and
selecting, via the processor, a second user to pick up along the shared ride hail trip, wherein the second user is selected based on the first user group ride hail preference.

3. The method according to claim 1, further comprising.
awarding the first user game points further based on information associated with competition settings.

4. The method according to claim 3, further comprising.
determining that a second user game objective matches the first user game objective;
awarding second user game points based on a second user action; and
generating the first user game points and the second user game points, wherein the first user game points and the second user game points are displayable on one or more mobile devices associated with the first user and a second user.

5. The method according to claim 1, further comprising.
determining, via the processor, a localized position of a vehicle providing the shared ride hail trip;
determining, based on the localized position and the first user game objective, that the first user is proximate to a bonus point award location; and
generating, via the processor, a user message displayable on a mobile device associated with the first user, wherein the user message is indicative that the first user is near the bonus point award location.

6. The method according to claim 1, further comprising.
determining, via the processor, a localized position of a vehicle providing the shared ride hail trip;
determining, based on the localized position and the first user game objective, that the first user may receive a point penalty based on an impending user action; and
generating, via the processor, a user message displayable on a mobile device associated with the first user, wherein the user message is indicative that the first user may receive the point penalty based on the impending user action.

7. The method according to claim 6, further comprising.
determining, via the processor, based on the first user game objective and the ride hail provider objective, an alternate action suggestion; and
generating, via the processor, the user message displayable on the mobile device associated with the first user, wherein the user message comprises:
the alternate action suggestion; and
an indication that the first user may avoid the point penalty based on following the alternate action suggestion.

8. The method according to claim 1, further comprising.
generating, via the processor, a competitive score output having a shared ride hail points aggregation; and
generating, via the processor, a user message displayable on a mobile device associated with the first user, wherein the user message is indicative of the competitive score output.

9. The method according to claim 1, wherein
the first user game objective comprises a first user fitness goal; and
the first user action comprises a physical activity associated with the first user fitness goal.

10. The method according to claim 9, further comprising:
receiving, from a sensory device, one or more of a biometric indicator, a distance indicator, and a travel velocity indicator associated with the physical activity; and
awarding the first user game points based on an indication of physical exertion associated with the physical activity.

11. The method according to claim 1, wherein the first user game objective comprises an environmental conservation objective.

12. The method according to claim 11, further comprising:
determining, via the processor, that the first user action satisfies the environmental conservation objective; and
awarding the first user game points based on the first user action.

13. The method according to claim 11, wherein the environmental conservation objective comprises reducing vehicle emissions, further comprising:
awarding the first user game points based on one or more of:
a reduction in vehicle travel in comparison with the ride hail route option; and
a reduction in total vehicle emissions in comparison with an estimate of vehicle emissions associated with the ride hail route option.

14. The method according to claim 1, wherein the first user game objective comprises a time conservation objective.

15. The method according to claim 14, further comprising:
determining, via the processor, that the first user action satisfies the time conservation objective by reducing travel time for one or more second users; and
awarding the first user game points based on the first user action.

16. The method according to claim 1, further comprising:
generating, via the processor, the ride hail route option based on the first user game objective and one or more of the ride hail provider objective and a physicality constraint associated with the first user.

17. The method according to claim 16, further comprising:
determining, via the processor, that the first user action satisfies a physicality constraint associated with one or more second users; and
awarding the first user game points based on the first user action.

18. The method according to claim 16, wherein the physicality constraint comprises one or more of:
a volume of luggage associated with the first user or a second user;
a physical mobility limitation; and
age of the first user or the second user.

19. A system for providing a gaming platform for a shared ride hail trip, comprising:
a processor; and
a memory for storing executable instructions, the processor programmed to execute the instructions to:
determine a first user game objective for a first user requesting the shared ride hail trip;
determine a ride hail provider objective associated with the shared ride hail trip;
generate a ride hail route option based on the first user game objective and the ride hail provider objective, wherein the ride hail route option comprises a drop off location at a final destination associated with the first user; and
award first user game points based on a first user action.

20. A non-transitory computer-readable storage medium in a computing device for providing a gaming platform for a shared ride hail trip, the computer-readable storage medium having instructions stored thereupon which, when executed by a processor, cause the processor to:
determine a first user game objective for a first user requesting the shared ride hail trip;
determine a ride hail provider objective associated with the shared ride hail trip;
generate a ride hail route option based on the first user game objective and the ride hail provider objective, wherein the ride hail route option comprises a drop off location at a final destination associated with the first user; and
award first user game points based on a first user action.
